(19) United States
(12) Patent Application Publication
(10) Pub. No.: US 2013/0162033 A1
(43) Pub. Date: Jun. 27, 2013

(54) POWER-SUPPLY DEVICE

(71) Applicants: Toshinori Origane, Aichi (JP); Kazushi Kodaira, Aichi (JP); Masayuki Miyashita, Aichi (JP); Shinji Horio, Aichi (JP)

(72) Inventors: Toshinori Origane, Aichi (JP); Kazushi Kodaira, Aichi (JP); Masayuki Miyashita, Aichi (JP); Shinji Horio, Aichi (JP)

(21) Appl. No.: 13/728,426

(22) Filed: Dec. 27, 2012

(30) Foreign Application Priority Data
Dec. 27, 2011 (JP) 2011-285098

(51) Int. Cl. G05F 3/08; B60R 16/02

(52) U.S. Cl. CPC G05F 3/08; B60R 16/02
USPC 307/10.6; 323/350

(57) ABSTRACT

A power-supply device has a DC power supply, a load, a booster circuit disposed between the DC power supply and the load, wherein the booster circuit supplies a voltage at the DC power supply to the load while boosting the voltage, a bypass element disposed between the DC power supply and the load, wherein the bypass element constitutes a bypass path with respect to the booster circuit, a controller that controls an operation of the booster circuit, a first switching element that drives the bypass element in a first driving path, and a second switching element that drives the bypass element in a second driving path.

### BACKGROUND OF THE INVENTION

1. Technical Field

The present invention relates to a power-supply device that supplies a voltage at a DC power supply to a load while boosting the voltage.

2. Related Art

Conventionally, various power-supply devices are well known in order to supply a DC voltage to various instruments and circuits, which are mounted on an automobile. For example, each of Japanese Unexamined Patent Publication Nos. 2005-112250, 2010-183755, 2011-162065, and 2005-160284 discloses a power-supply device including a DC-DC converter. The DC-DC converter includes a booster circuit, the booster circuit includes a switching element, a coil, and a capacitor, and the boosted DC voltage is output by switching the voltage at the DC power supply at high speed.

Some automobiles include what is called an idling stop function, in which the automobile automatically tentatively stops an engine when waiting at a stoplight and automatically restarts the engine during starting. In the automobile including the idling stop function, because a large current is passed through a starter motor during the engine restart, a battery voltage drops largely to generate such an abnormal state that the instrument or the circuit is reset. Therefore, it is necessary to boost the battery voltage in order to compensate the voltage drop.

In the power-supply devices disclosed in Japanese Unexamined Patent Publication Nos. 2005-112250, 2010-183755, and 2011-162065, the DC-DC converter is provided between the battery and the load, and a bypass relay constituting a bypass path is provided with respect to the DC-DC converter. The DC voltage is supplied from the battery to the load through the bypass relay during a normal run, and the boosted DC voltage is supplied from the battery to the load through the DC-DC converter during the engine restart. Therefore, the drop of the power supply voltage can be compensated during the engine restart to normally operate the instrument or the circuit, which is of the load.

The power-supply device disclosed in Japanese Unexamined Patent Publication No. 2005-160284 is mounted on an electric automobile, and the DC-DC converter is provided between the battery and an inverter in order to compensate the battery voltage drop due to a back electromotive force generated by the motor during the high-speed rotation of the motor. The bypass relay constituting the bypass path is provided with respect to the DC-DC converter. Whether the DC voltage at the battery is supplied to the load through the bypass relay or the DC-DC converter is switched based on an instruction from a feedback means.

FIG. 9 illustrates an example of the conventional power-supply device including the DC-DC converter. A power-supply device 200 is provided between a battery 1 and a load 2, and includes a DC-DC converter 3 and a bypass relay 20. For example, the load 2 is an electrically-assisted power steering of a vehicle. The DC-DC converter 3 includes a main relay 10, a booster circuit 11, an input interface 12, a CPU 13, and a transistor Q. The main relay 10 includes a coil Xa and a contact Ya. The bypass relay 20 includes a coil Xb and a contact Yb. An ignition signal from an ignition switch SW and a boosting request signal from a boosting request signal generator 4 are input to the CPU 13 through the input interface 12. For example, the boosting request signal generator 4 is an idling stop Electronic Control Unit (ECU).

While the vehicle runs, the ignition switch SW becomes ON (a closed state), and an H (High)-level ignition signal is input to the CPU 13. The CPU 13 turns on the transistor Q when receiving the H-level ignition signal. Therefore, the coil Xb of the bypass relay 20 is energized, and the contact Yb of the bypass relay 20 becomes ON. Accordingly, the DC voltage is supplied from the battery 1 to the load 2 through the contact Yb of the bypass relay 20. On the other hand, because the boosting request signal is not input to the CPU 13 from the boosting request signal generator 4, the CPU 13 does not drive the main relay 10, but the contact Ya of the main relay 10 is OFF (an opened state). Because the CPU 13 does not drive the booster circuit 11, the DC-DC converter 3 does not perform a boosting operation.

When the engine restarts after the vehicle stops to become the idling stop state, an L (Low)-level boosting request signal is input to the CPU 13 from the boosting request signal generator 4. When receiving the L-level boosting request signal, the CPU 13 turns off the transistor Q, energizes the coil Xa of the main relay 10, and drives the booster circuit 11. Because the coil Xb of the bypass relay 20 is not energized by turning off the transistor Q, the contact Yb of the bypass relay 20 becomes OFF. On the other hand, because the coil Xa of the main relay 10 is energized, the contact Ya of the main relay 10 becomes ON. Accordingly, the boosted DC voltage is supplied from the battery 1 to the load 2 through the contact Ya and the booster circuit 11.

The contact of the relay is roughly divided into a normally-opened contact and a normally-closed contact. The normally-opened contact is opened when the coil is not energized, and the normally-opened contact is closed when the coil is energized. On the other hand, the normally-closed contact is closed when the coil is not energized, and the normally-closed contact is opened when the coil is energized. In the power-supply device 200 in FIG. 9, the contact Yb of the bypass relay 20 is the normally-opened contact. Because generally a large amount of current can be passed through the normally-opened contact compared with the normally-closed contact, the normally-opened contact is suitable to the case that the load 2 is the electrically-assisted power steering necessary for the large amount of current.

However, in the case that the normally-closed contact is used as the contact Yb of the bypass relay 20, the energization of the coil Xb of the bypass relay 20 is cut to open the contact Yb when the transistor Q is turned off due to the breakdown of the CPU 13 or the transistor Q during a running state of the vehicle. Therefore, unfortunately the voltage is not supplied from the battery 1 to the load 2, and a necessary steering assistant force is not obtained in the case that the load 2 is the electrically-assisted power steering.

### SUMMARY

One or more embodiments of the present invention provides a power-supply device, which can continuously supply the voltage from the power supply to the load even if the breakdown of the circuit is generated.

In accordance with one or more embodiments of the present invention, a power-supply device includes: a booster circuit that is provided between a DC power supply and a load, the booster circuit supplying a voltage at the DC power supply to the load while boosting the voltage; a bypass element that is provided between the DC power supply and the load, the bypass element constituting a bypass path with respect to the booster circuit; a controller that controls an operation of the booster circuit; a first switching element that drives the bypass element in a first driving path; and a second switching element that drives the bypass element in a second driving path. Based on an externally-input first signal, the first switching element and the second switching element are turned on to drive the bypass element through the first driving path and the second driving path, and the controller puts the booster circuit in a non-operating state to supply a voltage from the DC power supply to the load through the bypass element. Based on an externally-input second signal, the first switching element and the second switching element are turned off to stop the drive of the bypass element through the first driving path and the second driving path, and the controller puts the booster circuit in an operating state to supply the voltage from the DC power supply to the load through the booster circuit.

According to the above configuration, the bypass element is driven through the driving paths of two systems of the first switching element and the second switching element. Even if one of the switching elements becomes OFF due to the breakdown of the circuit while the bypass element is in the operating state, the driving path is ensued by the other switching element. Therefore, the bypass element is maintained in the operating state, and the voltage can continuously be supplied from the DC power supply to the load.

In the power-supply device, the bypass element may be a bypass relay that includes a coil and a contact, the first switching element may be a first transistor that is connected in series with the coil of the bypass relay, and the second switching element may be a second transistor that is connected in parallel with the first transistor.

The power-supply device may further include a main relay that is operated based on the second signal. In this case, a contact of the main relay is connected in series with the booster circuit, and the contact of the bypass relay is connected in parallel with the booster circuit and the contact of the main relay.

In the power-supply device, the first switching element may be turned on and off by a control signal, which is output by the controller based on the first signal and the second signal, and the second switching element may be turned on and off by the first signal and the second signal without the controller.

In the power-supply device, the first signal may be an ignition signal that is generated based on an operation of an ignition switch of a vehicle, and the second signal may be a boosting request signal that is generated when an engine restarts after the vehicle becomes an idling stop state.

According to one or more embodiments of the present invention, the power-supply device, which can continuously supply the voltage from the power supply to the load even if the breakdown of the circuit is generated, can be provided.

### BRIEF DESCRIPTION OF THE DRAWINGS

FIG. 1 is a circuit diagram of a power-supply device according to embodiments of the invention;

FIG. 2 is a circuit diagram when the power-supply device is in a state #1;

FIG. 3 is a circuit diagram when the power-supply device is in a state #2;

FIG. 4 is a circuit diagram when the power-supply device is in a state #3;

FIG. 5 is a circuit diagram when the power-supply device is in a state #4;

FIG. 6 is a circuit diagram when the power-supply device is in a state #5;

FIG. 7 is a timing chart illustrating an operation of the power-supply device;

FIG. 8 is a table illustrating control logic of a CPU; and

FIG. 9 is a circuit diagram of a conventional power-supply device.

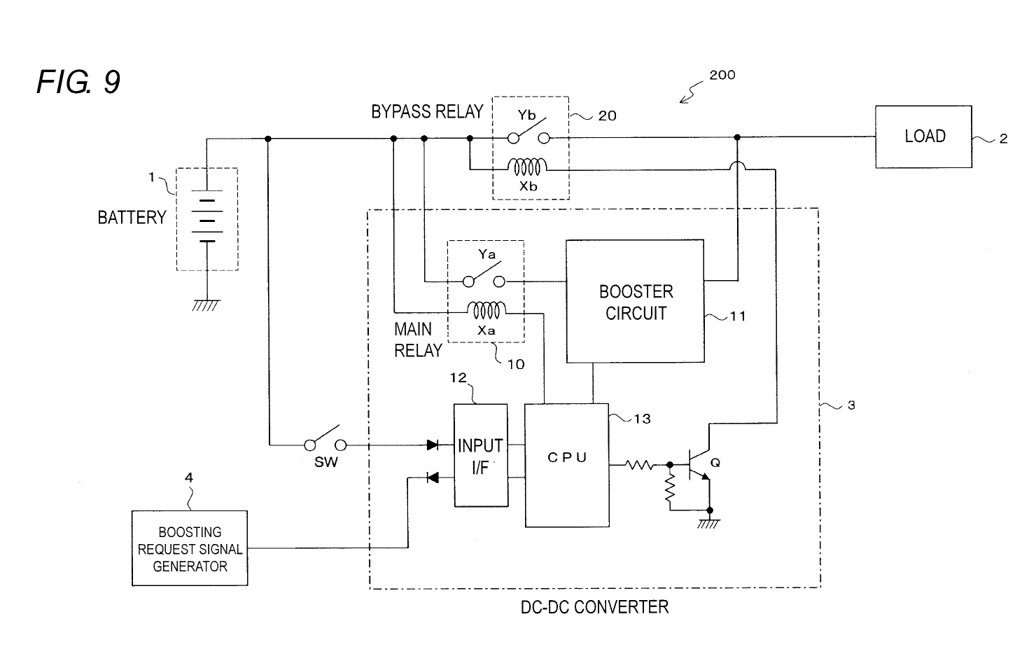

### DETAILED DESCRIPTION

Hereinafter, embodiments of the invention will be described with reference to the drawings. In the following drawings, the same or equivalent component is designated by the same numeral. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

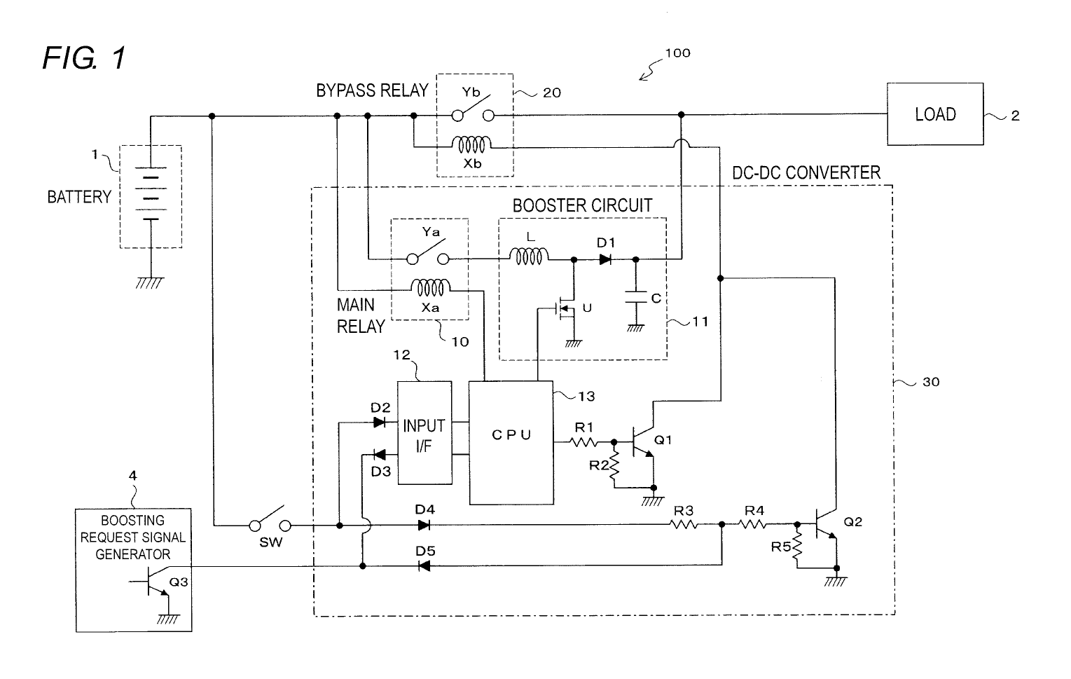

A configuration of a power-supply device according to embodiments of the present invention will be described with reference to FIG. 1. A power-supply device 100 is provided between a battery 1 and a load 2, and includes a bypass relay 20 and a DC-DC converter 30. In one or more embodiments of the present invention, the battery 1 is a DC power supply that is mounted on an automobile, and the load 2 is an electrically-assisted power steering that provides a steering assistant force using an electric motor.

The bypass relay 20 is a normally-opened relay, and includes a coil Xb and a contact Yb. One end of the coil Xb is connected to a positive electrode of the battery 1, and the other end is connected to the DC-DC converter 30. One end of the contact Yb is connected to the positive electrode of the battery 1, and the other end is connected to the load 2. A negative electrode of the battery 1 is grounded.

The DC-DC converter 30 includes a main relay 10, a booster circuit 11, an input interface 12, a CPU 13, a transistor Q1 (the first transistor), and a transistor Q2 (the second transistor).

The booster circuit 11 is a well-known circuit including a switching element U that performs an on-off operation, a boosting coil L, a rectifying diode D1, and a smoothing capacitor C. For example, the switching element U is constructed by a MOS-FET, and performs a switching operation in response to a control signal output from the CPU 13. A high voltage that is generated in the coil L by the on-off operation of the switching element U is rectified by the diode D1, smoothed by the capacitor C, and supplied to the load 2 as a boosted DC voltage.

The main relay 10 is a normally-opened relay, and includes a coil Xa and a contact Ya. One end of the coil Xa is connected to a positive electrode of the battery 1, and the other end is connected to the CPU 13. One end of the contact Ya is connected to the positive electrode of the battery 1, and the other end is connected to one end of the coil L of the booster circuit 11. The other end of the coil L is connected to the load 2 through the diode D1.

Accordingly, in the configuration in FIG. 1, the booster circuit 11 and the contact Ya of the main relay 10 are connected in series between the battery 1 and the load 2, and the contact Yb of the bypass relay 20 is connected in parallel with the booster circuit 11 and the contact Ya of the main relay 10.

An ignition switch SW is provided between the battery 1 and the DC-DC converter 30. One end of the ignition switch SW is connected to the positive electrode of the battery 1. The other end of the ignition switch SW is connected to the input interface 12 through the diode D2, and connected to a base of the transistor Q2 through a diode D4 and resistors R3 and R4.

In one or more embodiments of the present invention, a boosting request signal generator 4 is an idling stop ECU. A brake signal or a vehicle speed signal is input to the boosting request signal generator 4 from a brake switch (not illustrated) or a vehicle speed sensor (not illustrated). An output transistor Q3 included in the boosting request signal generator 4 performs the on-off operation in response to the brake signal or the vehicle speed signal. An output of the boosting request signal generator 4 is provided to the input interface 12 through a diode D3, and provided to the base of the transistor Q2 through a diode D5 and the resistor R4.

The input interface 12 is provided on an input side of the CPU 13, and provides an ignition signal (the first signal) input from the ignition switch SW and a boosting request signal (the second signal) input from the boosting request signal generator 4 to the CPU 13. The CPU 13 controls the main relay 10, the booster circuit 11, and the transistor Q1 based on the ignition signal and the boosting request signal.

A collector of the transistor Q1 is connected to the coil Xb of the bypass relay 20, and an emitter of the transistor Q1 is grounded. That is, the transistor Q1 is connected in series with the coil Xb of the bypass relay 20. The base of the transistor Q1 is connected to the CPU 13 through a resistor R1. A resistor R2 is connected between the base and the emitter of the transistor Q1.

The collector of the transistor Q2 is connected to the coil Xb of the bypass relay 20, and connected to the collector of the transistor Q1. The emitter of the transistor Q2 is grounded. That is, the transistor Q2 is connected in parallel with the transistor Q1. A resistor R5 is connected between the base and the emitter of the transistor Q2.

In the above configuration, the bypass relay 20 is an example of the “bypass element” in one or more embodiments of the present invention, the CPU 13 is an example of the “controller” in one or more embodiments of the present invention, the transistor Q1 is an example of the “first switching element” in one or more embodiments of the present invention, and the transistor Q2 is an example of the “second switching element” in one or more embodiments of the present invention. The battery 1, the coil Xb, and the collector and the emitter of the transistor Q1 constitute the “first driving path” in one or more embodiments of the present invention, and the battery 1, the coil Xb, and the collector and the emitter of the transistor Q2 constitute the “second driving path” in one or more embodiments of the present invention.

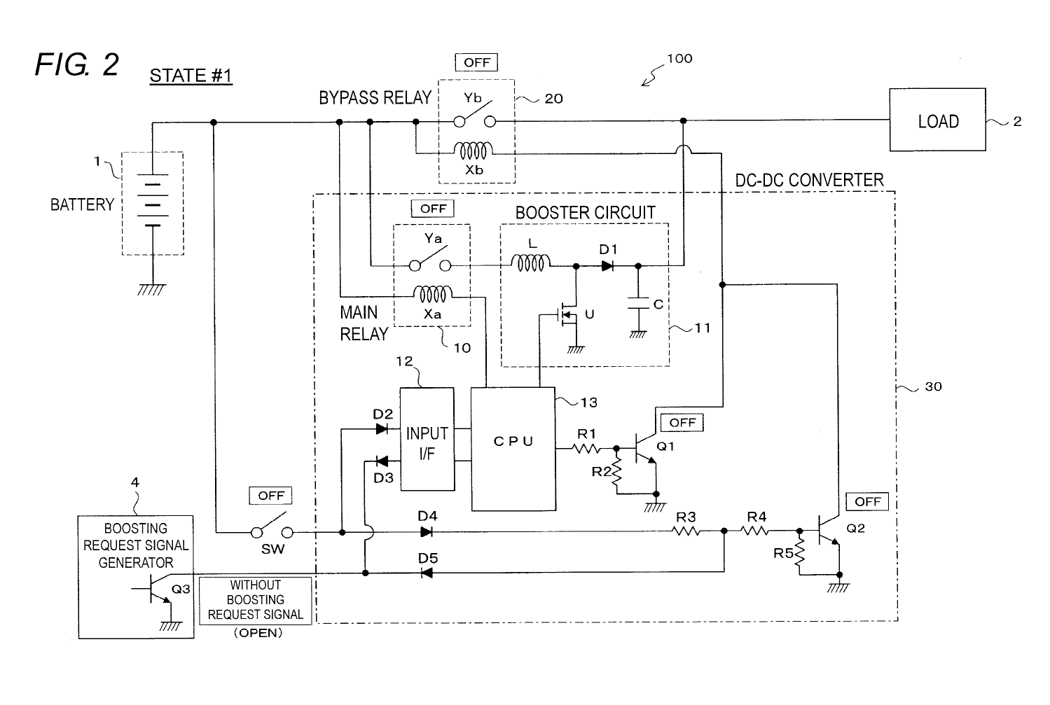

An operation of the power-supply device 100 having the above configuration will be described below with reference to FIGS. 2 to 6.

In the case that the vehicle is stopped, the power-supply device 100 is in a state #1 in FIG. 2. That is, the ignition switch SW is OFF, and the ignition signal is not input to the DC-DC converter 30. Because the output transistor Q3 of the boosting request signal generator 4 is also OFF, the output of the boosting request signal generator 4 is in an open state. Therefore, the boosting request signal is not input to the DC-DC converter 30.

At this point, the CPU 13 does not drive the main relay 10, the booster circuit 11, and the transistor Q1. Therefore, the contact Ya of the main relay 10 is OFF, the booster circuit 11 is in a non-boosted state, and the transistor Q1 is OFF. Because the ignition signal and the boosting request signal are not provided, the transistor Q2 is also OFF. Accordingly, the contact Yb of the bypass relay 20 is OFF because the coil Xb of the bypass relay 20 is not energized. As a result, the voltage is not supplied from the battery 1 to the load 2.

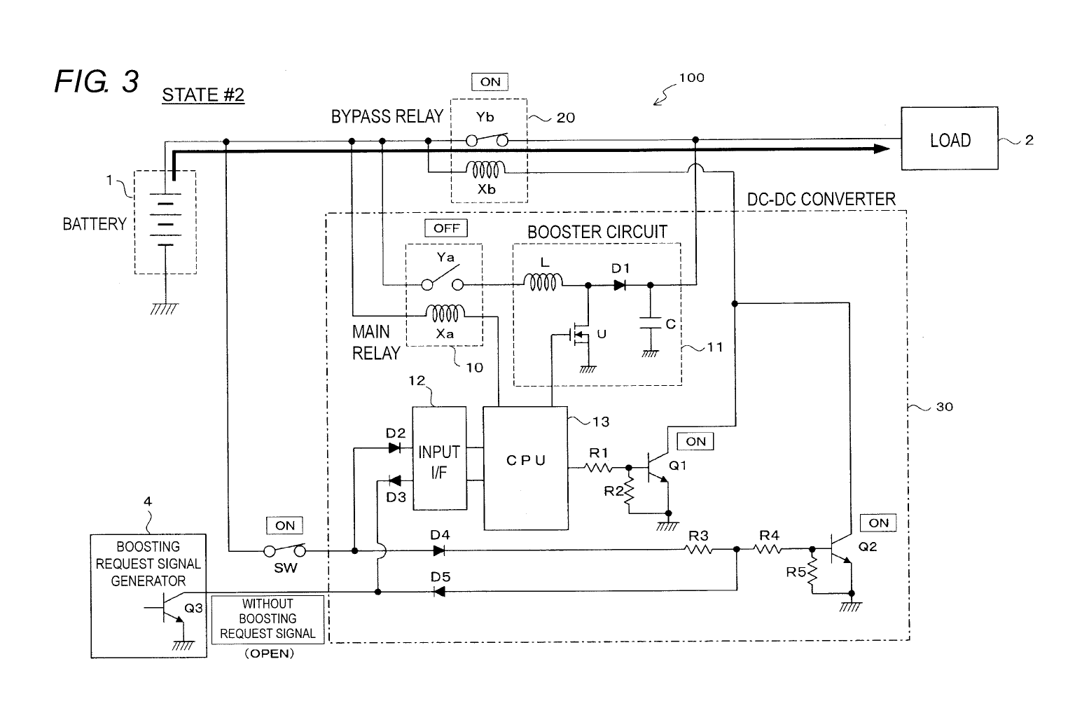

In the case that the vehicle is running, the power-supply device 100 is in a state #2 in FIG. 3. That is, the ignition switch SW is ON, and the H-level ignition signal is input from the battery 1 to the DC-DC converter 30 through the ignition switch SW. The ignition signal is provided to the CPU 13 through the diode D2 and the input interface 12, and provided to the base of the transistor Q2 through the diode D4 and the resistors R3 and R4. On the other hand, because the output transistor Q3 of the boosting request signal generator 4 is OFF, the boosting request signal is not input to the DC-DC converter 30.

At this point, the transistor Q2 becomes ON by the ignition signal from the ignition switch SW. The CPU 13 outputs an H-level control signal to the base of the transistor Q1 through the resistor R1 while being late by a time (hereinafter referred to as an “input fixed time”) from when the ignition signal is input to when the signal input is fixed in the CPU 13. Therefore, the transistor Q1 is tuned on slightly behind the transistor Q2. On the other hand, because the CPU 13 does not drive the main relay 10 and the booster circuit 11, the contact Ya of the main relay 10 is OFF, and the booster circuit 11 is in the non-boosted state.

Accordingly, the transistors Q1 and Q2 are ON to energize the coil Xb of the bypass relay 20 from the battery 1, whereby the contact Yb of the bypass relay 20 becomes ON. As a result, as indicated by a bold arrow in FIG. 3, a current path from the battery 1 to the load 2 through the contact Yb of the bypass relay 20 is formed to directly supply the voltage at the battery 1 to the load 2 without passing through the DC-DC converter 30.

In the case that the vehicle becomes an idling stop state when waiting at a stoplight, the state #2 in FIG. 3 is maintained until the idling stop is released.

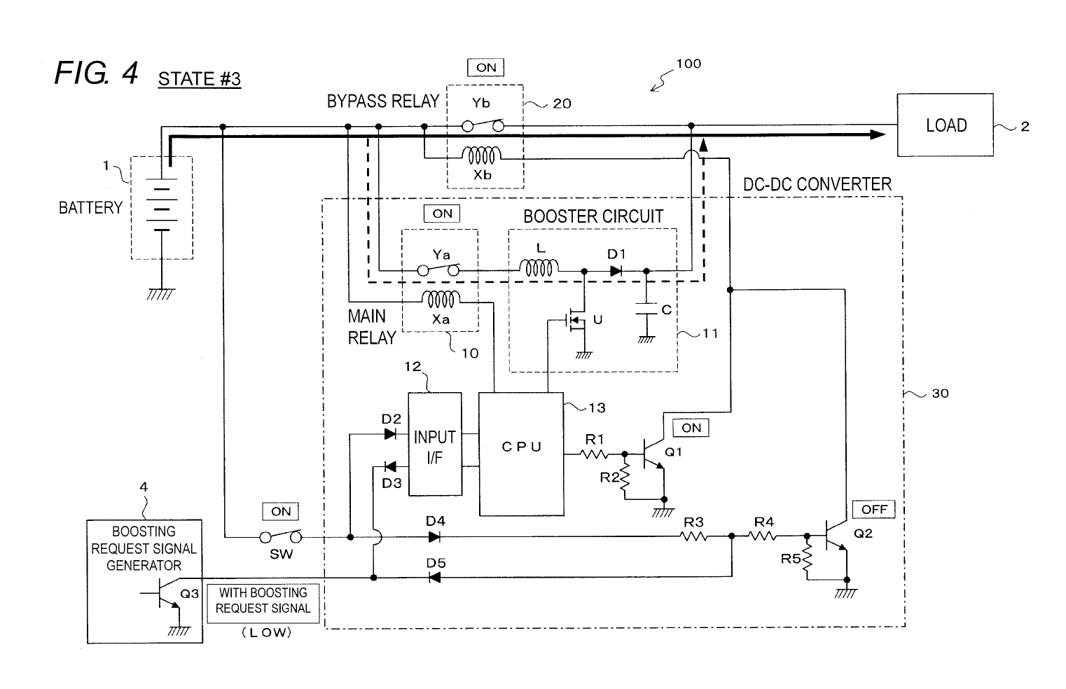

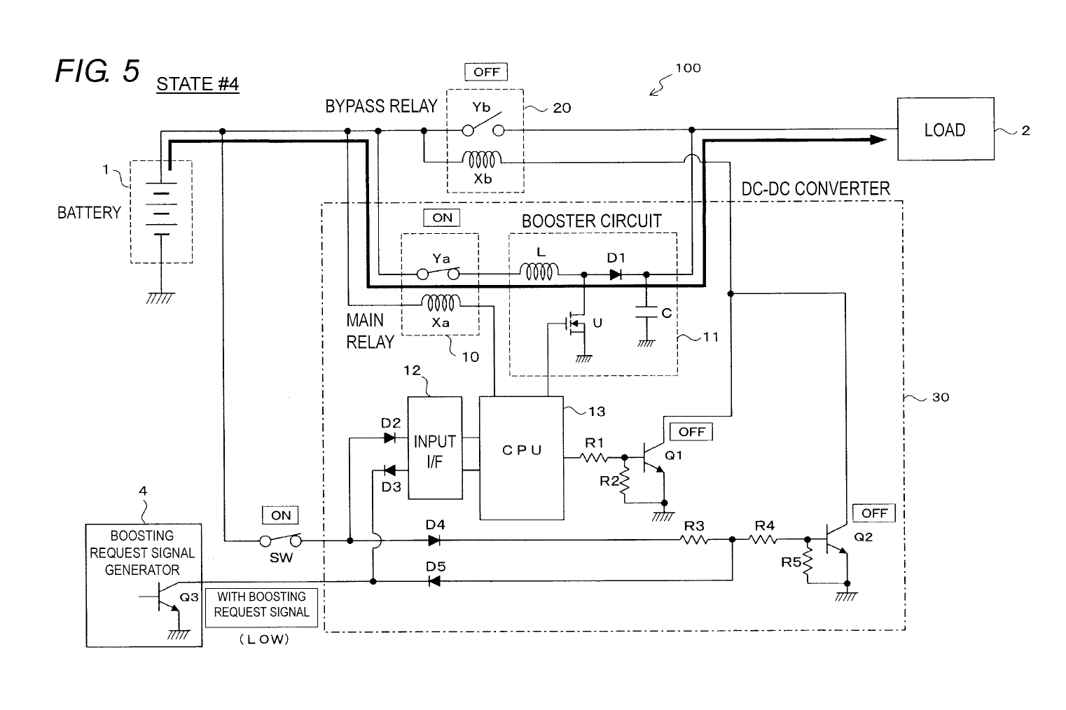

When the idling stop is released to restart an engine after the vehicle becomes the idling stop state, the power-supply device 100 transitions to a state #4 in FIG. 5 after tentatively becoming a state #3 in FIG. 4. The state #3 in FIG. 4 will be described. When the engine restarts after the idling stop, the transistor Q3 of the boosting request signal generator 4 becomes ON, and the boosting request signal generator 4 outputs the L-level boosting request signal. The L-level boosting request signal is provided to the CPU 13 through the diode D3 and the input interface 12, and provided to the base of the transistor Q2 through the diode D5 and the resistor R4. On the other hand, the ignition switch SW remains in ON.

The transistor Q2 instantaneously becomes OFF because the base of the transistor Q2 becomes a low potential by the boosting request signal. On the other hand, in response to the boosting request signal, the CPU 13 outputs the L-level control signal to the base of the transistor Q1 while being late by a time slightly longer than the input fixed time to turn the transistor Q1 OFF. Accordingly, the transistor Q1 does not becomes instantaneously OFF. Therefore, the coil Xb of the bypass relay 20 is continuously energized, the contact Yb is ON, and the current path indicated by the bold arrow in FIG. 4 is maintained.

In response to the boosting request signal, the CPU 13 drives the main relay 10 while being late by the input fixed time. As a result, the coil Xa of the main relay 10 is energized from the battery 1, and the contact Ya becomes ON. At this point, the booster circuit 11 maintains the not-boosted state because the CPU 13 does not drive the booster circuit 11.

As described above, both the contact Yb of the bypass relay 20 and the contact Ya of the main relay 10 tentatively become ON in the state #3 in FIG. 4. As a result, the current path (a solid-line arrow) from the battery 1 to the load 2 through the contact Yb and the current path (a broken-line arrow) from the battery 1 to the load 2 through the contact Ya, the coil L, and the diode D1 are formed.

Then, when the transistor Q1 becomes OFF, the power-supply device 100 becomes a state #4 in FIG. 5. At this point, because both the transistors Q1 and Q2 are OFF, the coil Xb of the bypass relay 20 is not energized, but the contact Yb of the bypass relay 20 becomes OFF. Because the CPU 13 drives the switching element U of the booster circuit 11 at the same time as the transistor Q1 becomes OFF, the booster circuit 11 is operated to become the boosted state. As a result, as indicated by the bold arrow in FIG. 5, the current path from the battery 1 to the load 2 through the DC-DC converter 30 is formed, and the voltage at the battery 1 is supplied to the load 2 while boosted by the booster circuit 11. Therefore, a voltage drop of the battery 1 is compensated during the engine restart.

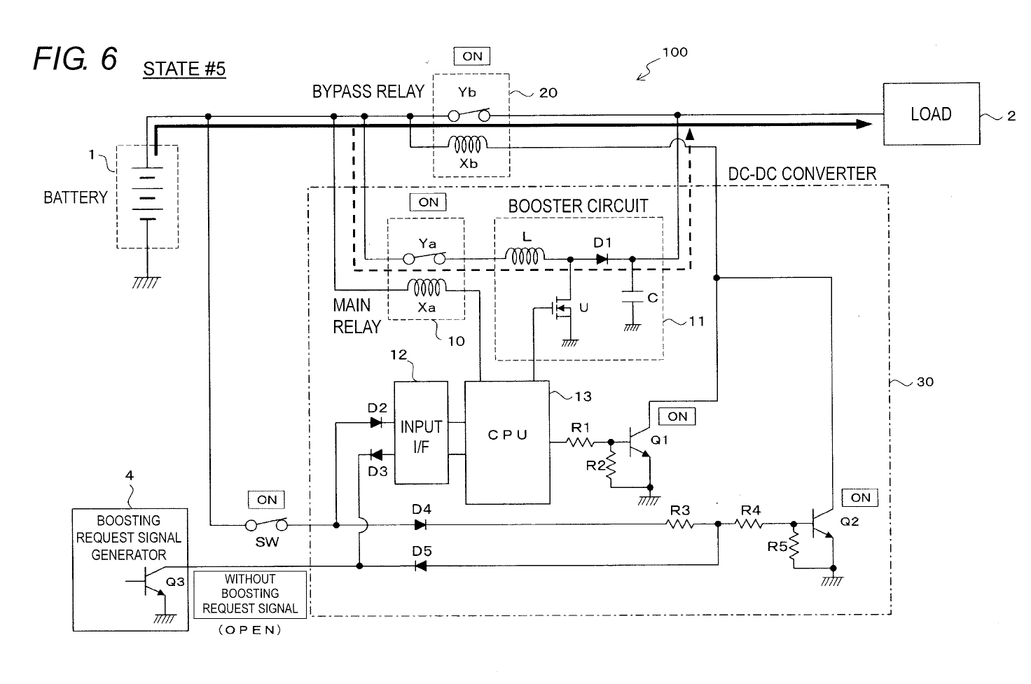

When the vehicle becomes a normal running state after the engine is restarted, the power-supply device 100 makes a transition to the state #2 in FIG. 3 after a tentative state #5 in FIG. 6. When the vehicle becomes a normal running state, the output transistor Q3 of the boosting request signal generator 4 is OFF, but the boosting request signal generator 4 does not output the boosting request signal as illustrated in FIG. 6. On the other hand, the ignition switch SW remains in ON. Therefore, both the transistors Q1 and Q2 become ON to energize the coil Xb of the bypass relay 20, whereby the contact Yb of the bypass relay 20 becomes ON. In response to the elimination of the boosting request signal, the CPU 13 stops the main relay 10 and the booster circuit 11. In this case, the CPU 13 puts the booster circuit 11 into the not-boosted state while being late by the input fixed time. The CPU 13 stops the energization of the coil Xa of the main relay 10 while being late by the time slightly longer than the input fixed time. Therefore, the contact Ya of the main relay 10 does not instantaneously become OFF.

Accordingly, both the contact Yb of the bypass relay 20 and the contact Ya of the main relay 10 tentatively become ON in the state #5 in FIG. 6. As a result, the current path (a solid-line arrow) from the battery 1 to the load 2 through the contact Yb and the current path (a broken-line arrow) from the battery 1 to the load 2 through the contact Ya, the coil L, and the diode D1, are formed.

Then, when the contact Ya of the main relay 10 becomes OFF, the power-supply device 100 becomes the state #2 in FIG. 3, and the voltage at the battery 1 is directly supplied to the load 2 through the contact Yb of the bypass relay 20 without passing through the DC-DC converter 30.

When the vehicle stops, the power-supply device 100 transitions to the state #1 in FIG. 2, and both the contact Yb of the bypass relay 20 and the contact Ya of the main relay 10 become OFF to stop the supply of the voltage from the battery 1 to the load 2.

As described above, the power-supply device 100 makes the transition among the states #1 to #5 according to the state of the vehicle.

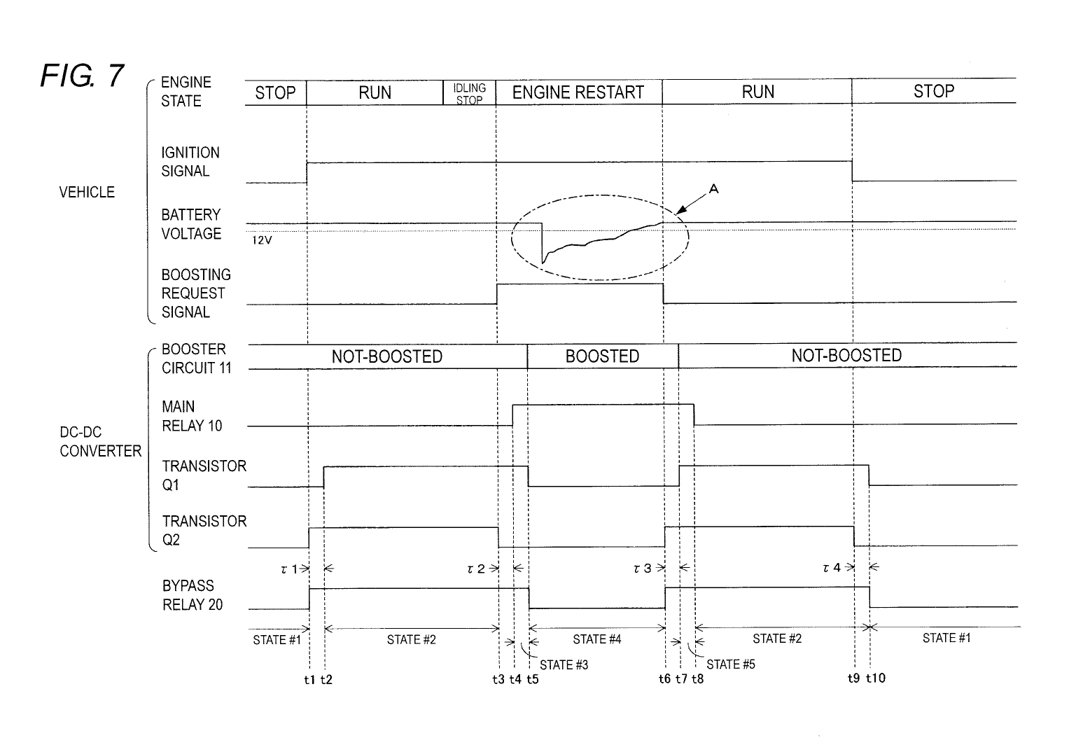

FIG. 7 is a timing chart illustrating the above operation of the power-supply device 100.

Until a clock time t1, the vehicle is in a stopped state. At this point, the ignition switch SW does not output the ignition signal, and the boosting request signal generator 4 does not output the boosting request signal. Therefore, the booster circuit 11 is in the not-boosted state. The main relay 10 and the transistors Q1 and Q2 are OFF (the state #1 in FIG. 2).

At the clock time t1, when the ignition switch SW become ON to start the run of the vehicle, the transistor Q2 becomes ON by the ignition signal, the bypass relay 20 is driven, and the contact Yb becomes ON. As a result, the voltage is supplied from the battery 1 to the load 2 through the contact Yb.

At a clock time t2 when an input fixed time T1 elapses since the clock time t1, the transistor Q1 becomes ON by the control signal output from the CPU 13. That is, both the transistors Q1 and Q2 become ON (the state #2 in FIG. 3). The state #2 in FIG. 3 is maintained even if the vehicle becomes the idling stop state.

At a clock time t3, when the idling stop is released to restart the engine, the boosting request signal generator 4 outputs the boosting request signal. The transistor Q2 becomes OFF by the boosting request signal. At a clock time t4, the contact Ya of the main relay 10 becomes ON while being late by an input fixed time T2 (the state #3 in FIG. 4).

At a clock time t5, the transistor Q1 becomes OFF. Both the transistors Q1 and Q2 are OFF, whereby the contact Yb of the bypass relay 20 becomes OFF. The booster circuit 11 is driven by the CPU 13 to become the boosted state. Therefore, the voltage is supplied from the battery 1 to the load 2 through the DC-DC converter 30 (the state #4 in FIG. 5). Accordingly, as indicated by an alternate long and short dash line (a portion A) in FIG. 7, the voltage at the battery 1, which drops to 12 [V] or less by the engine restart, is boosted by the DC-DC converter 30 and recovered to an original level of 12 [V] or more.

At a clock time t6, when the vehicle becomes the normal running state, the boosting request signal generator 4 does not output the boosting request signal, but the transistor Q2 becomes ON. Therefore, the bypass relay 20 is driven, and the contact Yb becomes ON. At a clock time t7 when an input fixed time T3 elapses, the transistor Q1 becomes ON, and the booster circuit 11 becomes the non-boosted state (the state #5 in FIG. 6).

At a clock time t8, the contact Ya of the main relay 10 becomes OFF. Therefore, the voltage is supplied from the battery 1 to the load 2 through the contact Yb of the bypass relay 20 (the state #2 in FIG. 3).

At a clock time t9, when the vehicle stops, the transistor Q2 becomes OFF because the ignition signal is eliminated. At a clock time t10 when an input fixed time T4 elapses, the transistor Q1 becomes OFF. As a result, because both the transistors Q1 and Q2 become OFF, the contact Yb of the bypass relay 20 becomes OFF (the state #1 in FIG. 2).

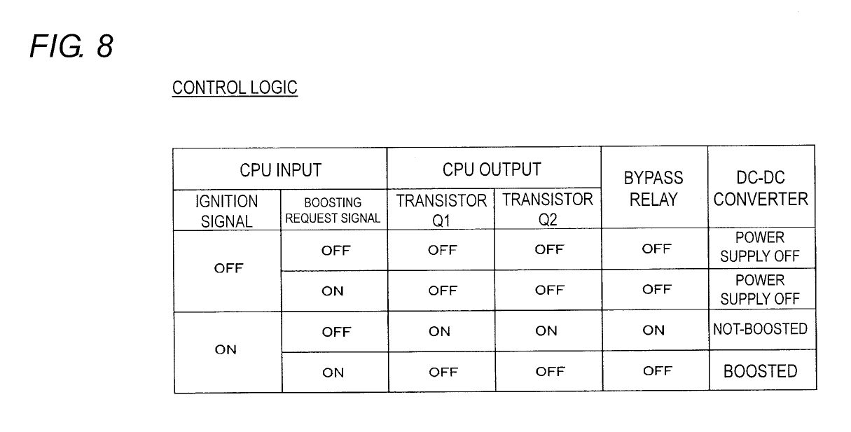

FIG. 8 is a table illustrating control logic of the CPU 13 in the above operation.

According to one or more embodiments of the present invention, the bypass relay 20 is driven by the driving paths of two systems, namely, the first driving path including the transistor Q1 and the second driving path including the transistor Q2. As can be seen from FIG. 7, when the vehicle is in the running state, both the transistors Q1 and Q2 are ON except extremely short time intervals (t1 and t2, and t6 and t7) of the input fixed times. Even if one of the transistors Q1 and Q2 becomes OFF due to the breakdown of the circuit or the element itself, the driving path is ensured by the other transistor. Therefore, the coil Xb of the bypass relay 20 is continuously energized to maintain the contact Yb in the on state, and the voltage can be supplied from the battery 1 to the load 2 (the electrically-assisted power steering). As a result, the situation that the steering assistant force is not suddenly obtained during the driving can be avoided.

In one or more embodiments of the present invention, the transistor Q1 is turned on and off by the control signal, which is output from the CPU 13 based on the ignition signal and the boosting request signal, and the transistor Q2 is turned on and off by the ignition signal and the boosting request signal without the CPU 13. Therefore, the transistor Q2 is maintained in the on state even if the CPU 13 is broken down to turn off the transistor Q1 while the vehicle runs. Accordingly, the voltage can be supplied from the battery 1 to the load 2 without an influence of the breakdown of the CPU 13.

Various modifications can be made in embodiments of the present invention. For example, in one or more embodiments of the present invention, the bypass relay 20 is used as the bypass element. Alternatively, a large-current opening and closing semiconductor switching element may be used instead of the bypass relay 20. Similarly, instead of the main relay 10, a semiconductor switching element may be used as the element that connects and disconnects the booster circuit 11 to and from the battery 1

In one or more embodiments of the present invention, the bipolar transistors Q1 and Q2 are used as the switching element that drives the bypass relay 20. Alternatively, FETs may be used instead of the bipolar transistors Q1 and Q2.

In one or more embodiments the present invention, the power-supply device 100 that supplies the DC voltage to the electrically-assisted power steering is described by way of example. However, one or more embodiments of the present invention can be applied to applications except the power-supply device.

In one or more embodiments of the present invention, by way of example, the drop of the battery voltage is compensated during the engine restart. However, one or more embodiments of the present invention can also be applied in the case that the drop of the battery voltage due to a back electromotive force is compensated during the high-speed rotation of the motor of the electric automobile like Japanese Unexamined Patent Publication No. 2005-160284.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A power-supply device comprising:
a DC power supply;
a load;
a booster circuit disposed between the DC power supply and the load, wherein the booster circuit supplies a voltage at the DC power supply to the load while boosting the voltage;
a bypass element disposed between the DC power supply and the load, wherein the bypass element constitutes a bypass path with respect to the booster circuit;
a controller that controls an operation of the booster circuit;
a first switching element that drives the bypass element in a first driving path; and
a second switching element that drives the bypass element in a second driving path,
wherein, based on an externally-input first signal, the first switching element and the second switching element are turned on to drive the bypass element through the first driving path and the second driving path, and the controller puts the booster circuit in a non-operating state to supply a voltage from the DC power supply to the load through the bypass element, and
wherein, based on an externally-input second signal, the first switching element and the second switching element are turned off to stop the drive of the bypass element through the first driving path and the second driving path, and the controller puts the booster circuit in an operating state to supply the voltage from the DC power supply to the load through the booster circuit.

2. The power-supply device according to claim 1, wherein
the bypass element is a bypass relay that includes a coil and a contact,
the first switching element is a first transistor that is connected in series with the coil of the bypass relay, and
the second switching element is a second transistor that is connected in parallel with the first transistor.

3. The power-supply device according to claim 2, further comprising:
a main relay that is operated based on the second signal,
wherein a contact of the main relay is connected in series with the booster circuit, and
wherein the contact of the bypass relay is connected in parallel with the booster circuit and the contact of the main relay.

4. The power-supply device according to claim 1,
wherein the first switching element is turned on and off by a control signal, which is output by the controller based on the first signal and the second signal, and
wherein the second switching element is turned on and off by the first signal and the second signal without the controller.

5. The power-supply device according to claim 1,
wherein the first signal is an ignition signal that is generated based on an operation of an ignition switch of a vehicle, and
wherein the second signal is a boosting request signal that is generated when an engine restarts after the vehicle becomes an idling stop state.

6. The power-supply device according to claim 2,
wherein the first switching element is turned on and off by a control signal, which is output by the controller based on the first signal and the second signal, and
wherein the second switching element is turned on and off by the first signal and the second signal without the controller.

7. The power-supply device according to claim 3,
wherein the first switching element is turned on and off by a control signal, which is output by the controller based on the first signal and the second signal, and
wherein the second switching element is turned on and off by the first signal and the second signal without the controller.

8. The power-supply device according to claim 2,
wherein the first signal is an ignition signal that is generated based on an operation of an ignition switch of a vehicle, and
wherein the second signal is a boosting request signal that is generated when an engine restarts after the vehicle becomes an idling stop state.

9. The power-supply device according to claim 3,
wherein the first signal is an ignition signal that is generated based on an operation of an ignition switch of a vehicle, and
wherein the second signal is a boosting request signal that is generated when an engine restarts after the vehicle becomes an idling stop state.

10. The power-supply device according to claim 4,
wherein the first signal is an ignition signal that is generated based on an operation of an ignition switch of a vehicle, and
wherein the second signal is a boosting request signal that is generated when an engine restarts after the vehicle becomes an idling stop state.

11. The power-supply device according to claim 6,
wherein the first signal is an ignition signal that is generated based on an operation of an ignition switch of a vehicle, and
wherein the second signal is a boosting request signal that is generated when an engine restarts after the vehicle becomes an idling stop state.

12. The power-supply device according to claim 7,
wherein the first signal is an ignition signal that is generated based on an operation of an ignition switch of a vehicle, and
wherein the second signal is a boosting request signal that is generated when an engine restarts after the vehicle becomes an idling stop state.
